(19) United States
(12) Patent Application Publication
(10) Pub. No.: US 2023/0325171 A1
(43) Pub. Date: Oct. 12, 2023

(54) METHOD FOR UPDATING EMBEDDED SOFTWARE

(71) Applicant: COMMISSARIAT A L'ENERGIE ATOMIQUE ET AUX ENERGIES ALTERNATIVES, PARIS (FR)

(72) Inventors: Bastien CHAPUIS, TRESSERVE (FR); Julien ALBERTINI, PARIS (FR); Alban TRESARRIEU, VERSAILLES (FR)

(21) Appl. No.: 18/024,960

(22) PCT Filed: Sep. 10, 2021
(86) PCT No.: PCT/EP2021/074933

§ 371 Date: Mar. 6, 2023

(30) Foreign Application Priority Data
Sep. 11, 2020 (FR) 2009237

(51) Int. Cl. G06F 8/65; B61L 23/04; B61L 27/70; B61L 27/53

(52) U.S. Cl. CPC G06F 8/65; B61L 23/042; B61L 27/70; B61L 27/53

(57) ABSTRACT

A method for software update of software embedded in an electronic device having a nominal operating mode making it possible to exchange messages with a remote server according to a long-range low-speed communication protocol, where the messages contain information generated by the embedded software. The method is computer-implemented and comprises at least steps consisting in: receiving, via the long-range low-speed communication protocol, a message for activating a short-range high-speed communication protocol; activating the short-range high-speed communication protocol; halting the nominal operating mode; and updating the embedded software with a software update received via the short-range high-speed communication protocol.

### CROSS-REFERENCE TO RELATED APPLICATIONS

This application is a National Stage of International patent application PCT/EP2021/074933, filed on Sep. 10, 2021, which claims priority to foreign French patent application No. FR 2009237, filed on Sep. 11, 2020, the disclosures of which are incorporated by reference in their entirety.

### FIELD OF THE INVENTION

The invention relates to the software update field, and relates in particular to updating embedded software for monitoring a structure implementing guides of elastic waves, and notably monitoring a railroad track.

### BACKGROUND

Updating embedded software for monitoring structures implementing guides of elastic waves relates to many industrial fields. Various elongate industrial structures take the form of guides of elastic waves, for example a rail in the railroad field or structures of gantry type. A pipe (notably in the oil or nuclear fields) transporting a fluid is also an elongate structure for which it may be critical to check the integrity. Likewise cables, for example for passenger transport systems (cable car or other), are elongate structures which make it possible to implement guides of elastic waves.

Thus, in the railroad sector, the rail is a critical structure, the integrity of which must be monitored. Subject to very strong thermomechanical forces (e.g. internal stresses due to frustrated thermal expansion, trains passing), the rail portions wear out over time and may sometimes be subject to clean breaks. The state of the tracks must be monitored in order to diminish or even eliminate the risks of derailment. Maintaining a railroad network represents a major challenge in terms of cost and safety for railroad operators.

One known approach to monitoring the state of the rails consists in arranging, along the rail, transducers (a transducer may also be referred to by the term “sensor”) which transmit elastic waves guided through the rails, which waves interact with defects (a breakage or other, more minor defect). A diffracted signal is then analyzed by specialized software in an electronic device or “electronic node”, in order to detect and locate a defect. Thus, a device for monitoring a railroad track may comprise a plurality of electronic nodes which are distributed in a network over the rails, each node being able to be associated with one or more transducers and performing a local analysis of the signals which it receives by virtue of embedded analysis software. The results of the analyses of the nodes may be communicated to a remote server in order to make a more comprehensive analysis possible, in general by means of a wireless communication technology.

According to the size and the more or less complex nature of the embedded analysis software, and according to the communication technology or protocol existing between the electronic nodes and the one or more remote servers, difficulties may arise with regard to updating the embedded software.

Specifically, the communication speeds may be higher or lower, and require more or less energy to transmit data.

For example, although cellular communications of GSM/3G/4G/5G type make it possible to send large amounts of data, this technology involves costs through the subscriptions to be made, and excessive energy consumption for a railroad track monitoring application. It is, then, not adapted to the software update of analysis software embedded in each electronic node of a network of electronic nodes.

Conversely, communications protocols with low electrical consumption such as the LoRaWAN protocol for the Internet of things, which is the acronym of Long-Range Wide-Area Network, make low-speed communications, by radio according to the LoRa technology, possible. A major limitation of this type of protocol is the impossibility of sending large amounts of data. Also, fixing any bugs or deploying any new functionality over a network of connected objects requires physical connection to each of the objects in order to fix a bug or inject a new software version. Such an operation is lengthy, and presents risks of damaging the housings enclosing the electronic circuits. In the case of a railroad track monitoring application where electronic nodes communicate with a remote server through LoRa technology, fixes or updates by a physical person present major risks in terms of safety as the nodes are near to the tracks. Thus, low-speed protocols of LoRa type are not adapted to remotely updating software embedded in each electronic node.

Recently the LoRa alliance has proposed a solution named “FUOTA” for “Firmware Update Over The Air”, considering that updating a network of sensors is a critical functionality without which industrial deployment is barely conceivable. The article by Khaled Abdelfadeel et al., arXiv: 2002.08735v1 [cs.NI] 20 Feb. 2020 titled ‘How to make Firmware Updates over LoRaWan Possible’, studies FUOTA update scenarios for small embedded software (100 kB maximum) corresponding to applications where the embedded processing operations are not very complex. It is demonstrated therein that the updates for a single node, in an unfavorable case where the node is far from the LoRa gateway, may take several hours. The FUOTA solution is, then, not adapted to the case of the software update of a railroad track monitoring system having an extended network of electronic nodes each embedding electronic circuits meant to run an operating system of Linux type in order to operate complex analysis software which may be several MB. Updating such software using the FUOTA approach would take too long, would involve a significant service interruption, and would be very costly in energy terms for an autonomous system.

There is, then, a need for a solution for updating embedded software which mitigates the aforementioned drawbacks.

### SUMMARY OF THE INVENTION

The present invention may be used for monitoring cables, pipes or any other elongate structure, that is to say which has a favored direction, which may act as a guide of elastic waves for which the monitoring technique is based on analyzing elastic waves.

The invention lies as a matter of priority in the context of updating software embedded in electronic devices or nodes installed along railroad rails, which nodes communicate data for analyzing the state of the rail to a remote server via a low-speed protocol of LoRaWAN type. Other extended networks with low energy consumption, which are generically defined by the term “LPWAN” for “Low-Power Wide-Area Network”, may be used.

More generally, the invention will find an application in any environment having a network of connected objects communicating with a remote server via a low-speed low-consumption protocol.

One subject of the present invention is a method for remote software update, i.e. without a physical connection, of electronic nodes of a system for monitoring an elongate structure.

In a general implementation, the invention exploits the ability of an electronic node to work according to various modes of communication. When an update of the embedded software is planned for a node (and, by extension, for a plurality of nodes), an order is transmitted, i.e. a message in the LoRa format is sent to the one or more nodes of the network, in order to activate a high-speed local-range protocol (Wi-Fi or another protocol, such as Bluetooth) over the one or more nodes. The software update is then sent on the fly via the activated high-speed protocol, by virtue of a mobile device (transported by a train, an operator or a drone), passing near to the nodes. The high-speed protocol is immediately deactivated on each node at the end of its software update, in order to lower the electrical consumption of the node.

Unlike the FUOTA system of the prior art, the device of the invention makes it possible to keep the monitoring system entirely up to date without drastically increasing the update duration, even in the event of the size of the update files increasing, whether this is for functional updates making it possible to improve the embedded algorithms or for security updates such as, for example, when the Linux kernel changes.

One subject of the present invention is a device for remotely updating embedded software, comprising means for carrying out the method of the invention, which has, among other advantages, those of:
limiting, through rapid interventions, the service interruptions for the software update;
offering a low cost of intervention, either by an operator who does not need to physically connect to the node, or by a drone or a train;
reinforcing the cybersecurity as it leaves fewer opportunities to deposit malicious code in a node, by leaving a high-speed communication channel open only temporarily, unlike the configurations where a high-speed communication channel is open permanently;
having low consumption for the software update, by switching a high-speed local-range communication protocol on only temporarily;
making it possible to maintain the rail monitoring service a large part of the time.

Communication protocols with low energy consumption use free radio frequencies; they are, then, not very costly in terms of deployment, and it is possible to deploy them on a site if no pre-existing network is available there, unlike 4G deployments.

As this type of communication protocol with low energy consumption does not make it possible to communicate large files, the device of the present invention is configured so that defect detection algorithms are embedded in software form in each electronic node in order to perform local diagnosis. The result is then transmitted to a remote server. Advantageously, the messages generated by the nodes may be limited to a few bits (i.e. provide YES/NO binary information indicating that the rail is or is not damaged) or contain a few bytes (i.e. provide a slightly more elaborate message containing finer information, for example on a defect criticality level, a location, a type, etc.).

A remote server recovers the messages originating from the nodes, in order to pool the local information passed on by each node, and refine the diagnosis in order to guarantee actual defects are detected and limit the false positives.

Advantageously, in the context of the invention, the long-range low-speed communication protocol (e.g. LoRa, Sigfox, etc.) makes it possible to transmit, to a remote server, simplified information on the state of health of the node and of a rail portion which is reduced to a few nodes. After all of the received basic information has been analyzed and processed in the server (by a supervisor module), it is determined whether there is probably a defect present, whether this is a clean break, an incipient break or wear.

Advantageously, in the context of the invention, the short-range high-speed communication protocol (e.g. Wi-Fi, Bluetooth, etc.) makes it possible to transmit, to a node, a software update with a very small impact on the nominal operation of the node, by activating the high-speed local-range communication protocol only for the time it takes to download the code of the update.

In order to obtain the desired results, a method is proposed for software update of software embedded in an electronic device having a nominal operating mode for exchanging messages with a remote server according to a long-range low-speed communication protocol, the messages containing information generated by said embedded software, the method being computer-implemented and comprising the steps of:
receiving, via the long-range low-speed communication protocol, a message for activating a short-range high-speed communication protocol;
activating said short-range high-speed communication protocol;
halting the nominal operating mode; and
updating the embedded software with a software update received via the short-range high-speed communication protocol.

According to alternative or combined embodiments:

The step of activating the short-range high-speed communication protocol comprises the steps of:
receiving, via the short-range high-speed communication protocol, a request to connect to a mobile device transporting a software update for said embedded software;
receiving, via the short-range high-speed communication protocol, said software update if the request is accepted; and deactivating the short-range high-speed communication protocol.

The method comprises, after the step of updating the embedded software, a step of reactivating the nominal operating mode of the electronic device.

The long-range low-speed communication protocol is a protocol of LPWAN type, and the messages exchanged with the remote server are in the LoRa format.

The short-range high-speed communication protocol is a protocol of Wi-Fi or Bluetooth type.

The method comprises, after the step of receiving, via the short-range high-speed communication protocol, a request to connect to a mobile device, a step of authenticating the identity of the mobile device and of checking the integrity of the update code.

The step of authenticating the identity of the mobile device and of checking the integrity of the update code consists in checking the MAC algorithm.

The method further comprises a step of sending the remote server, via the long-range low-speed communication protocol, an update confirmation message, and a step of reactivating nominal operation.

The invention also covers a computer program product comprising non-volatile code instructions to perform the steps of the method of the invention when the program is executed on a computer.

The invention further covers a device for software update of software embedded in an electronic device having a nominal operating mode for exchanging messages with a remote server according to a long-range low-speed communication protocol, the messages containing information generated by said embedded software, the software update device comprising means for implementing the steps of the method of the invention.

In one embodiment, the electronic device is one electronic node among a plurality of electronic nodes each embedding software which can be updated, the plurality of electronic nodes being part of a system for monitoring the state of railroad tracks based on analyzing elastic waves guided through the rails.

The invention also covers a system for monitoring the state of railroad tracks based on analyzing elastic waves guided through the rails, the system comprising a plurality of electronic nodes, each electronic node comprising at least one piece of software for analyzing elastic waves guided through the rails, and further comprising means for establishing a nominal long-range low-speed communication mode for transmitting, to a remote server, messages in the LoRa format for diagnosing defects in the rails, and for establishing a temporary short-range high-speed communication mode for receiving software update data.

### BRIEF DESCRIPTION OF THE DRAWINGS

Other features and advantages of the invention will become apparent with the aid of the following description and the figures of the appended drawings, in which:

FIG. 1 illustrates a context in which the device of the invention is implemented for a railroad application;

FIG. 2 illustrates an example of a LoRaWAN topology which is applicable to implementing the invention;

FIG. 3 illustrates the typical structure of a LoRa packet;

FIG. 4 illustrates an example of the structure of an electronic node according to the invention;

FIG. 5 illustrates, on a time diagram, the general steps of the software update method of the invention in one embodiment.

### DETAILED DESCRIPTION

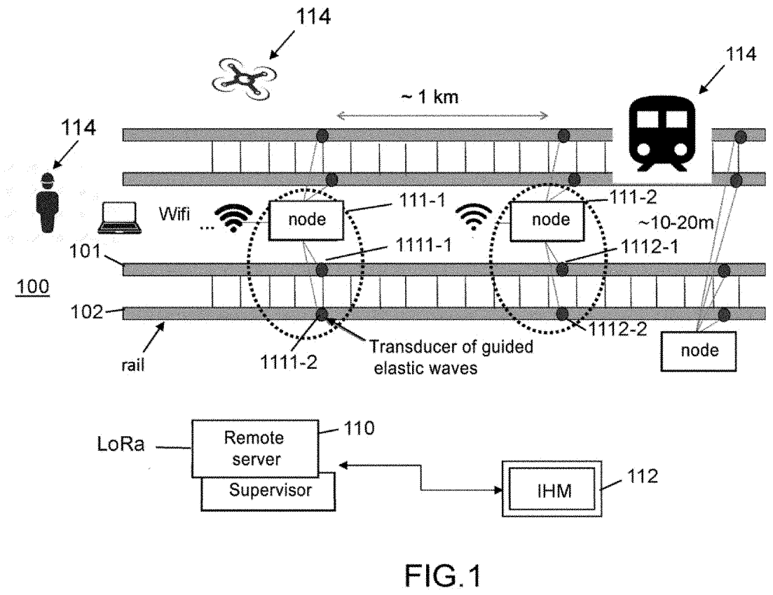

FIG. 1 illustrates an example of the implementation of the software update device of the invention for a railroad application. However, this example is non-limiting and a person skilled in the art will be able to adapt the described implementation to any other application implementing an elongate waveguide. In the described example, the waveguide is a rail.

FIG. 1 shows the rails 101, 102 of a railroad track 100 which are equipped with transducers of elastic waves 1111-1, 1112-1, 1111-2, 1112-2.

The term “equipped” means that the transducers may be found in one or more locations selected from: under the head, whether this is on the inner web of the rail and/or on the outer web of the rail, under the rail. In the illustrated example, two transducers (1111-1, 1111-2) are arranged on one of the two rails 101, 102, respectively, near to a first electronic node 111-1, and two transducers (1112-1, 1112-2) are arranged on one of the two rails 101, 102, respectively, near to a second electronic node 111-2.

A person skilled in the art understands that the example is taken in order to describe the principles of the invention but is non-limiting with regard to the number of transducers and nodes which may be deployed and to the distance between the nodes. For example, electronic nodes may be installed every kilometer along a railroad track.

Although not described, transducers may also be arranged on the rails of a second railroad track for train traffic in the other direction, these transducers being able to be coupled to the same electronic nodes as the first railroad track.

A transducer is a device which converts a physical signal into another one. There is a great variety of transducers. For generating and receiving acoustoelastic waves which are transmitted through a material (a rail, a tube, a structure, etc.), using an electromagnetic-acoustic transducer (EMAT) may constitute an alternative to using a piezoelectric transducer (PZT).

Each electronic node installed along a railroad track is configured, i.e. comprises at least one software module for analyzing elastic waves, to analyze signals originating from the transducers in order to determine the existence of a defect in the rails. Various types of elastic waves propagate between two transducers 1111-1 and 1112-1. Each transducer may operate simultaneously as a transmitter and as a receiver. Several signals are then usable, these signals corresponding to a wave transmitted from the transmitter to the receiver and vice versa, as well as a wave reflected when a transmitter is operating in pulse-echo mode (the same transducer playing the role of transmitter and of receiver). Thus, the presence and/or the absence of a transmitted and/or reflected wave indicates whether or not there is a defect present locally.

The electronic nodes are configured to communicate, with a remote server 110, messages indicating whether or not there is a defect present in the rail portion under consideration.

In the context of the invention, the communication of the defect diagnosis messages between the electronic nodes and the remote server is established according to a communication protocol with low energy consumption. In one embodiment, the protocol is LoRaWAN and the messages are formatted according to the LoRa frame structure.

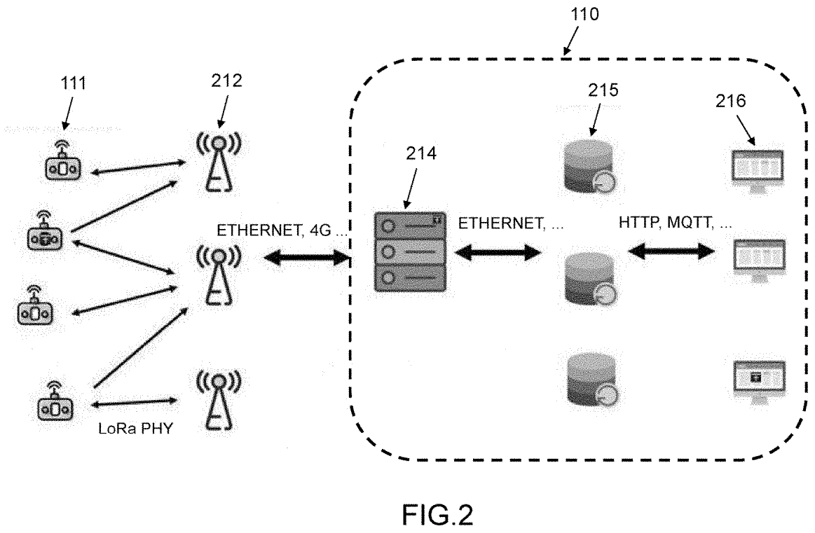

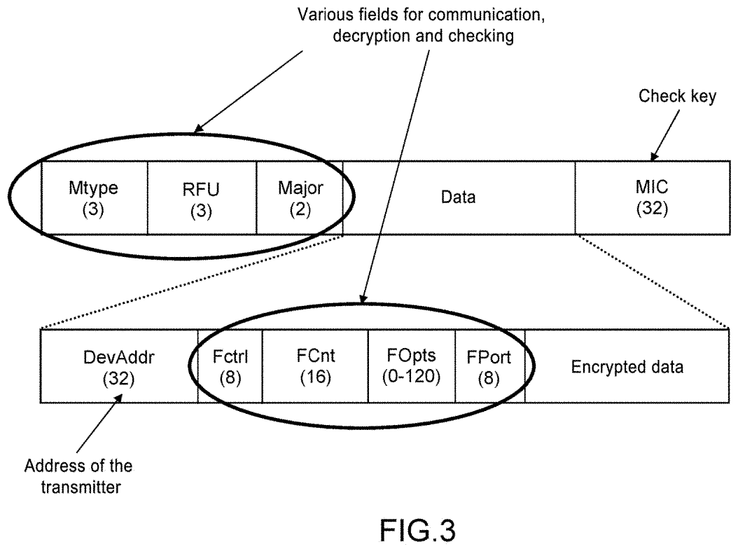

FIG. 2 illustrates an example of a LoRaWAN topology and FIG. 3 shows a known LoRa frame format.

LoRaWAN, for “Long-Range Wide-Area Network”, is a low-speed bidirectional radio-wave communication protocol which has several advantages:
low consumption;
low volume; and
low cost.

The frequency bands used are free (868 MHz, for example, in Europe) but limited (˜36 s/h for 868 MHz), which constrains the size of the data transmitted (to a few tens of kbits/h).

A typical LoRaWAN network shown in FIG. 2 is composed of items of low-consumption wireless equipment 111 which communicate with application servers 110 (grouping together a network server 214, application server 215 and application server 216) through gateways 212. The modulation technique used between the items of equipment 111 and the gateways 212 is LoRa. The communication between the gateways 212 and the servers 110 is established via the IP protocol by means of an Ethernet or 3G/4G backhaul network.

The LoRaWAN network topology is said to be in a star-of-stars configuration with, at the center, an application network server which is connected to a multitude of gateways which are themselves connected to a multitude of items of terminal equipment.

In the network sense, the items of equipment are not connected to the gateways (and are therefore not shown in FIG. 1). The gateways act only as relays for joining the server 214 managing the network, which is itself connected to one or more application servers 215, 216. The data packets sent by the items of equipment 111 are retransmitted by the gateways after having only added thereto information relating to the quality of the received signal.

FIG. 3 illustrates the typical structure of a LoRa packet where the sizes of the fields are indicated in bits, which is composed of a preamble, optionally a header, a field for the data and optionally an error check. The maximum size of the data is between 51 and 222 bytes according to the spreading factor (SF) used (the greater the SF the smaller the size of the data). The various fields contained in a LoRaWAN packet are:
Mtype: This field indicates the type of the message (upstream or downstream).
FU: This field is reserved for future use.
Major: This field indicates the version of the protocol used.
MIC: This field makes it possible to compute the integrity of the packet in order to detect whether it has been altered during transport.
DevAddr: This field contains the address of the item of equipment.
FCtrl: This field makes it possible to adapt the speed and the acknowledgements. It indicates the presence of additional packets as well as the length of the FOpts field.
FCnt: This field is a frame counter (incremented on each sending).
FOpts: This field makes it possible to pass MAC commands (check of connectivity by an item of equipment, for example).
FPort: This field contains the port of the application or of the service to which the packet is addressed.

A person skilled in the art will be able to refer to the existing literature in order to supplement the reading relating to the LoRa technology, such as the specification documents made available by the LoRaWAN Alliance.

Returning to FIG. 1, the remote server 110 is configured (i.e. comprises so-called supervision means) to combine the defect diagnosis messages received from the electronic nodes and containing local diagnosis information generated by the software module for analyzing defects of the electronic node which generated the message. The remote server performs a comprehensive defect diagnosis, which is precise because of the aggregation of the local diagnoses.

The analysis results may be displayed on an IHM interface 112 in a form which may be directly used by the user, visually indicating on a map of the track, for example, the location of the one or more defects, or in any other form adapted to the application. An alert may be sent to train drivers and/or to any traffic control system, and/or a brake command may be triggered depending on the result of the analysis.

In order to implement the software update method of the invention, the electronic nodes are configured to communicate according to a short-range high-speed protocol with a mobile device 114.

A mobile device within the meaning of the present invention may be any type of apparatus which is able to connect, according to a short-range high-speed protocol, to a node when it is close thereto. It may be rendered mobile autonomously or by being transported by an operator, a drone or a train traveling on the track as illustrated. The mobile device comprises at least one memory unit for storing a software update which has to be applied to the one or more nodes.

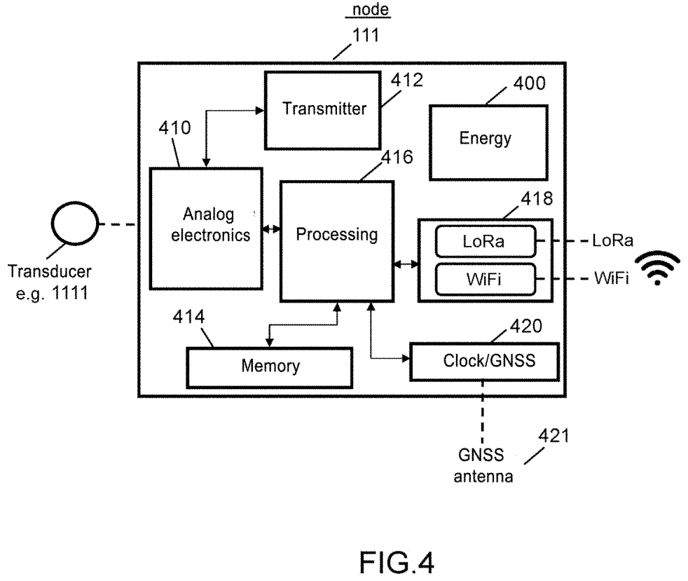

FIG. 4 illustrates an example of the structure of an electronic node 111 in an embodiment which makes it possible to perform a software update according to the method of the invention.

Generally, a node 111 comprises: an energy source 400 (e.g. electric power supply of battery or solar panel type, access to an external power supply, etc.); an electronic circuit comprising a circuit 410 for measuring elastic waves; a circuit 412 for transmitting elastic waves; storage components 414; a circuit 416 for processing the signal (FPGA, CPU or other for processing the received signals); a wireless communication circuit 418; a GNSS (geolocation and navigation by a system of satellites) receiver 420, for example of GPS type including an antenna 421 and the embedded electronics.

A node 111 is coupled to at least one transducer (e.g. 1111) of guided elastic waves, which is, for example, installed on a rail near to the node.

The energy source 400 may be provided by dynamo systems recharged by the passing of the trains on the railroad track and/or by one or more photovoltaic panels and/or by one or more wind turbines.

The wireless communication circuit 418 is configured to establish at least two modes of communication: a long-range low-speed communication mode (e.g. LoRa, Sigfox, etc.) and a short-range high-speed communication mode (e.g. Wi-Fi, Bluetooth, etc.).

The wireless communication circuit 418 comprises appropriate components and an associated antenna for transmitting defect diagnosis messages according to the LoRa long-range low-speed communication protocol, as well as appropriate components and an associated antenna for receiving, according to the Wi-Fi short-range high-speed protocol, software update data.

The GNSS circuit 420 may be shared between several transducers. A satellite positioning system, referred to as a GNSS (geolocation and navigation by a system of satellites) system, is based on a constellation of artificial satellites making it possible to provide, to a user or a circuit (via a portable receiver), its position, its speed and the time. In one embodiment, the GNSS circuits are associated with the transducers so as to precisely timestamp the signals measured by the transducers, while at the same time guaranteeing synchronization in under a microsecond between two nodes which are several kilometers apart (the distance does not matter as long as there is GNSS coverage on the two nodes under consideration).

In certain embodiments, the timestamping circuits and/or the computing circuits and/or the GNSS circuits may be variously distributed in space (e.g. the existence of centers, an entirely distributed system, a hierarchical arrangement between nodes).

The computing or signal processing circuit 416 is associated with computing and/or memory resources 414 which may be local or remote. The signal processing circuit 416 which is embedded in each node makes it possible, on the basis of the signals emanating from the elastic waves received from the nearby neighboring nodes, to perform a local diagnosis, relating to whether or not there is a defect present locally. The computing circuit and the defect analysis software 416 make it possible to determine or detect the existence of one or more local defects over a length of rail including several transducers, on the basis of synchronized measurements of the acoustoelastic waves propagating through the rail.

A local defect may be determined—its existence, its location, its category—by applying predefined thresholds, said predefined thresholds being determined with reference to an actual state, for example with respect to a state of the rail which is known to be healthy or with respect to a calibrated state of said rail, or with reference to a simulated state of the rail.

A defect may be characterized, notably regarding its nature, size, orientation in space or geometry, by an amplitude and/or frequency analysis and/or by an analysis of the shape of the signal and/or by an analysis of the frequency spectrum of the measurement signals and/or of the function which is representative of the pulsed response of the rail and/or by identifying a change in the mode of propagation of at least one of the waves propagating through the rail. A defect may notably be oriented horizontally or vertically. Depending on the analysis of the signals, the position and the size may be estimated. By learning or by comparison with abacuses extracted from mathematical or numerical models, quantitative characterization may make it possible to determine a type of defect (corrosion, fissure, discontinuity, etc.).

A defect may be characterized by differentiated diagnosis between the received signal being transmitted via the head of the rail and the one being transmitted via the web of the rail. For example, if the signal is transmitted to one end of the rail and not the other, it is possible to approximately determine the extent of the defect as well as its position in the section of the rail. In the event that no signal is transmitted, it is probable that the breakage of the rail is almost complete. In order to mitigate the diagnosis uncertainties, advantageously the device of the invention makes it possible to pass on all the local diagnoses to a supervisor (analysis module of a remote server) which aggregates all of the information in order to make it possible to comprehensively diagnose and precisely characterize a defect.

As each node has only fragmentary information on the overall system, the local and simplified diagnosis performed by a node is transmitted to the remote server 110, where supervision software makes it possible to aggregate the data from the nodes in order to improve the diagnosis, and transmit a final decision. Specifically, when a node does not receive a signal, it considers that there is a rail breakage, whereas this may occur because of the non-transmission of the signal by the transmitter. Thus, the server which aggregates the information received from the nodes will determine the state of said transmitting node. The analysis performed in the remote server thus makes it possible to refine defect detection and bring about better decisions.

Various scenarios for transmitting the local information received by each node to the remote server are possible, making more or less communication possible in a day. One implementation choice may be that of having messages which are as short as possible but frequent, and therefore containing only binary information on the state of health of each segment (for example, ‘0’ for ‘healthy’ and ‘1’ for ‘damaged’). More complete messages containing additional information such as the criticality or the position of the defect, an estimate of the size, the temperature, the state of health of the battery or the state of health of the node in the event of defective elements, may also be transmitted, but then at lower frequencies.

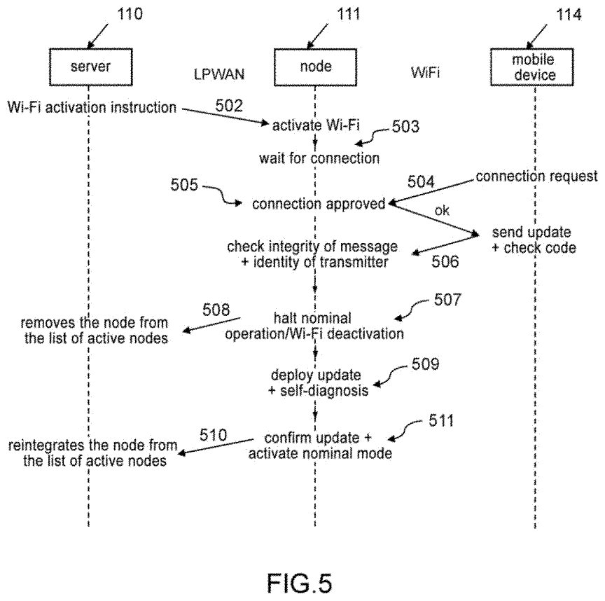

FIG. 5 illustrates, on a time diagram, the general steps of the software update method of the invention in one embodiment.

When an update of the software embedded in one or more electronic nodes 111 proves to be necessary, the remote server 110 sends 502, via the LPWAN communication protocol with low energy consumption, an order to the one or more nodes of the network in question, i.e. all or some of the plurality of nodes of the network, for example only those which are defective, an instruction to activate their high-speed (Wi-Fi or Bluetooth) communication network.

In one operating mode, the node may activate 503 its Wi-Fi communication component while at the same time maintaining normal activity of the node (its so-called nominal mode).

In one variant embodiment, the activation instruction received by the node may comprise a unique identification key or “secret key”, which will make it possible for the node to check, via known message authentication mechanisms (e.g. a MAC, for “message authentication code”) or another similar technique, the identity of the transmitter of the update, and the integrity of the update software code, which might possibly be altered during its transmission.

After the activation 503 of its Wi-Fi communication mode, the node is in a state of waiting to receive a connection request from a mobile device 114 transporting the software update. According to the nature of the mobile device and its mode of travel, it will pass near to the node waiting for connection, which is affected by the update. When it arrives near to the node, the connection request is approved by the node and the connection between the node 111 and the mobile device is established 504.

Once the connection has been approved 505 by the node, the mobile device sends 506 the update code to the node.

In an optional step, the node which previously received a secret key from the server may authenticate the identity of the transmitting mobile device which makes the connection request and, if applicable, authorize the uploading of the software into its internal memory.

In one variant embodiment, the step where the node checks the identity of the transmitter (mobile device) may be performed a posteriori by checking the well-known MAC algorithm. Specifically, only one legitimate transmitter should possess the secret key and therefore transmit the correct authentication code for the message. The secret key may be transmitted via the LoRa protocol with the update instruction or even be hard-coded into the node.

Once the update code has been received and, if applicable, once the validity of the software which is received by the node has been recognized, the node deactivates 507 the high-speed (Wi-Fi or Bluetooth) communication.

Simultaneously, the node 111 halts its nominal operation and informs 508 the server 110, which removes it from the list of the active nodes of the network.

The node 111 may then proceed to deploy 509 the received update.

In a following step 510, the node sends the server, via the LPWAN communication protocol with low energy consumption, a message to confirm that it is indeed up to date, then, in a following step 511, it reactivates its nominal operation (after an optional self-diagnosis phase).

The described software update method makes it possible for the interruption of the nominal mode of a node to be reduced to only the time it takes for the node itself to deploy the update (steps 507 to 511), and thus keep the monitoring service active a large part of the time.

Furthermore, the described software update method makes it possible for the consumption for a software update to be low, by virtue of a temporary activation of a high-speed local-range communication protocol (steps 502 to 507), which is limited to the time it takes to download the code from a mobile device to a node.

The invention may be implemented on the basis of hardware and/or software elements. It may be available as a computer program product on a computer-readable medium. The medium may be electronic, magnetic, optical or electromagnetic. The computing means or resources may be centralized and/or be distributed (Cloud computing), optionally with or according to peer-to-peer and/or virtualization and/or redundancy technologies. The software code may be executed on any suitable processor (for example a microprocessor) or processor core or set of processors, whether they are provided in a single computing device or distributed between several computing devices. The computing implementation of the invention may use centralized (e.g. client-server or master-slave) systems and/or distributed systems (e.g. an architecture of peer-to-peer type using accessible computing resources, optionally opportunistically, e.g. ad hoc networks, etc.). The system (or its variants) implementing one or more of the steps of the method may use one or more dedicated electronic circuits or a general-purpose circuit. The method may also be implemented on a reprogrammable computing machine (a processor or a microcontroller, for example) executing a program comprising a sequence of instructions, or on a dedicated computing machine (a set of logic gates such as an FPGA or an ASIC, or any other hardware module, for example). A dedicated circuit may notably improve performance. The reference to a computer program that, when it is executed, performs any one of the functions described above is not limited to an application program running on a single host computer. On the contrary, the terms “computer program” and “software” are used here in a general sense to refer to any type of computer code (for example application software, firmware, microcode, APIs, web services or any other form of computer instruction) which may be used to program one or more processors to implement steps of the method.

1. A method for software update of software embedded in an electronic device having a nominal operating mode for exchanging messages with a remote server according to a long-range low-speed communication protocol, the messages containing information generated by said embedded software, the method being computer-implemented and comprising at least steps of:
receiving via the long-range low-speed communication protocol, a message for activating a short-range high-speed communication protocol;
activating said short-range high-speed communication protocol;
halting the nominal operating mode; and
updating the embedded software with a software update received via the short-range high-speed communication protocol.

2. The method as claimed in claim 1, comprising, after the step of activating the short-range high-speed communication protocol, the steps of:
receiving, via the short-range high-speed communication protocol, a request to connect to a mobile device transporting a software update for said embedded software;
receiving, via the short-range high-speed communication protocol, said software update if the request is accepted; and
deactivating the short-range high-speed communication protocol.

3. The method as claimed in claim 1, comprising, after the step of updating the embedded software, a step of reactivating the nominal operating mode of the electronic device.

4. The method as claimed in claim 1, wherein the long-range low-speed communication protocol is a protocol of LPWAN type, and the messages exchanged with the remote server are in the LoRa format.

5. The method as claimed in claim 1, wherein the short-range high-speed communication protocol is a protocol of Wi-Fi or Bluetooth type.

6. The method as claimed in claim 2, comprising, after the step of receiving, via the short-range high-speed communication protocol, a request to connect to a mobile device, a step of authenticating the identity of the mobile device and of checking the integrity of the update code.

7. The method as claimed in claim 6, wherein the step of authenticating the identity of the mobile device and of checking the integrity of the update code consists in checking the MAC algorithm.

8. The method as claimed in claim 1, further comprising a step of sending the remote server, via the long-range low-speed communication protocol, an update confirmation message, and a step of reactivating nominal operation.

9. A computer program product, said computer program comprising code instructions for performing the steps of the method as claimed in claim 1 when said program is executed on a computer.

10. A device for software update of software embedded in an electronic device having a nominal operating mode for exchanging messages with a remote server according to a long-range low-speed communication protocol, the messages containing information generated by said embedded software, the software update device comprising means for implementing the steps of the method as claimed in claim 1.

11. The software update device as claimed in claim 9, wherein the electronic device is one electronic node among a plurality of electronic nodes each embedding software which can be updated, the plurality of electronic nodes being part of a system for monitoring the state of railroad tracks based on analyzing elastic waves guided through the rails.

12. A system for monitoring the state of railroad tracks based on analyzing elastic waves guided through the rails, the system comprising a plurality of electronic nodes, each electronic node comprising at least one piece of software for analyzing elastic waves guided through the rails, and further comprising means for establishing a nominal long-range low-speed communication mode for transmitting, to a remote server, messages in the LoRa format for diagnosing defects in the rails, and for establishing a temporary short-range high-speed communication mode for receiving software update data.
